(19) United States
(12) Patent Application Publication
(10) Pub. No.: US 2015/0316919 A1
(43) Pub. Date: Nov. 5, 2015

(54) Multifunctional Hydraulic Drive Unit

(71) Applicants: HYTORC Division UNEX Corporation, Mahwah, NJ (US); Juko Technik GmbH, Geretsried (DE)

(72) Inventor: Holger JUNKERS, Habach (DE)

(21) Appl. No.: 14/621,379

(22) Filed: Feb. 12, 2015

Related U.S. Application Data
(63) Continuation-in-part of application No. 13/885,845, filed on May 16, 2013.

(30) Foreign Application Priority Data
Feb. 12, 2014 (DE) 102014101714

(51) Int. Cl. G05B 19/18; G05B 15/02

(52) U.S. Cl. CPC G05B 19/182; G05B 15/02; G05B 2219/41273

(57) ABSTRACT

The present invention describes a multi-functional hydraulic assembly for driving hydraulic fools with the aim of fulfilling as many requirements as possible for a variety of system applications. This is realized, firstly, by a high-performance cooling and filtering concept, secondly, by modular cascadability of the motor and the electronics, or also the option to be able to attach any number of auxiliary reservoirs via suction lines or communicating systems. To meet the requirements of the industry in terms of data management, access and currentness, it is possible to control and to update the assembly and to bidirectionally exchange data via external central servers or via a cloud. Program data and/or process data and/or system data of the hydraulic assembly is by means of an online portal as a cloud service stored and analyzed for process evaluation and provided to an authorized group of individuals for download or via a web browser. A further cloud service informs the user and clients in automated form when maintenance of the assembly or the system is pending or necessary. Moreover, it is possible via the cloud to integrate all employed system accessories for the inclusion of maintenance intervals, thus creating a flexible overall system and ensuring the multifunctional use of the hydraulic assembly in the system network.

Multifunctional hydraulic assembly and method for controlling hydraulic tools and/or hydraulic assemblies with an interface for receiving process programs and sending process results for a remote process management, process evaluation or data backup, respectively, and suitable for stationary or nonstationary operation of the assembly with at the a same time centrally organized data management.

Hydraulic assemblies according to current prior art are used for driving and controlling hydraulic tool components. The assemblies employed are developed specific to the application and can therefore in terms of their hydraulic, electrical and process engineering options be employed in a very limited way.

Depending on the connected tool, e.g. a very different amount of usable oil volume and capacity is required. This results in there being a wide variety of assembly models.

The requirements for process control also differ greatly. For the operation of tools, such as hydraulic torque tools, the bolting parameters for programming the assemblies are set in different ways, mostly by means of individual parameters which are used for controlling. The setting is there in many cases done manually or the parameters are in a relatively uncomfortable and cumbersome manner entered in a sequence or sequentially loaded by a connected reader. Program-controlled systems, which are externally programmed, are triggered purely manually and are loaded by a connected storage such as a USB flash drive or a similar portable storage medium. Portable systems are also known which can be set by means of a manual pressure adjustment valve and a pressure gauge to adjust a desired operating pressure.

No systems are currently known in prior art that allow different externally stored programs—such as bolting programs for driving hydraulic bolting tools—to be loaded in the assembly either triggered or controlled Internally or externally, it is furthermore not possible to load them either directly from a server or from data storage such as “from the cloud” or locally from an Internal memory and/or to start them automatically

This leads, inter alia, to the fact that systems according to prior art at least in part have the following drawbacks:
The systems are not able to modularly satisfy the different requirements for the fluid reservoir, the delivery rate and the electrical connection data without a change of model,
The required properties for fluid cooling are not given in the systems.
The required properties for fluid nitration are not given in the systems.
Control parameters of the assembly must in a complicated way be loaded and stored individually or sequentially or manually.
It is not possible to control the assembly either via the cloud, a server, or locally.
No automated program download from an external central storage can be performed based on automated application recognition.
Any quality evaluation of process results controlled in an automated, centralized manner is not possible.
Variable usability for different process requirements using internal and/or additionally required external sensors is not given.
No centrally analyzed data is present that can be used for process evaluation.

Multifunctional usability of such assemblies and a centrally organized data storage and organization to ensure that data is up to date plays an increasingly important role, especially in the industry. This ensures, firstly, that programs of assemblies used worldwide for a variety of applications are up to date, and, secondly, that there is quick access to the process results.

It is an object of the present invention to overcome at least in part the drawbacks known In prior art and to provide a unit and/or method with which the drawbacks of prior art are solved or Improved at least in part.

This object is satisfied wish a device according to claim 1 and the method according to the invention according to claim 10. Advantageous embodiments of the present invention are each the object of the respective dependent claims.

The hydraulic assembly usable in a multifunctional way has a modular configuration that makes it possible to mount motors having different voltage, number of external conductors, and power on the same pump block to meet different requirements of supply sources. There furthermore exists at feast one electrical interface from the motor to the electronics, which can cover the entire voltage and current range, while simultaneously ensures a tight connection between the fluid-conveying pump or the hydraulic assembly and the power electronics mounted there on top. The power electronics comprises power switches which are in one embodiment implemented purely as on/off switches, in another embodiment as frequency converters. The electrical interface from the motor to the power electronics is embodied by a circuit board imprinted on both sides, where the printed circuit board by means of O-rings seals toward the motor casing or the tank (depending on the embodiment) against the fluid. The motor of the hydraulic assembly is due to lower noise emission preferably an oil-immersed motor, it can in another embodiment also be configured as a glanded one. Due to the arrangement of the pump and filling opening for the fluid, the motor can be operated vertically or horizontally relative to the footprint of the hydraulic assembly and is therefore operable in at least two orientations. The hand-held remote control of the hydraulic assembly is used to start and stop the process, can be configured as being wired or wireless and can for special applications be integrated into the removable operator interface so that this operator interface can be hand-held and control the start-stop functionality of the process. Process data visualization is also provided in the operator interface and outputs and graphically displays, firstly, the process status and, secondly, the process values. Furthermore, however, also a further analog pressure gauge can be mounted on the assembly to provide data redundancy for the user via an additional channel. A fluid radiator is attached at the face end of the motor directly in front of the motor fan so as to reduce the fluid temperature in extreme environmental conditions or operating conditions. The assembly can in a portable basic version provide fluid to the connected tool with its own internal useable volume. However, if multiple or particularly large tools, such as lifting cylinders, are connected or multitool operation is necessary, then a communicating external auxiliary reservoir with the same maximum fluid level as the hydraulic assembly can be connected to the hydraulic assembly. For this mode of operation, the closure cap on the hydraulic assembly is configured as a ventilation element and the connection to the hydraulic assembly is located at the bottom port to the reservoir of the assembly. With a communicating fluid connecting, the fluid level in the assembly is in dependence of the discharged fluid volume and the flow conditions at about the same level as the fluid level in the external auxiliary reservoir, in order to have the option of providing a larger volume of fluid to the pump at the same footprint, a active suction principle must be selected. For this, a ventilated auxiliary reservoir is again connected to a ventilated closure cap above the suction region of the uppermost pump element. For the suction variant, the closure cap on the hydraulic assembly is to be selected having a air-fight design, so that a vacuum can by fluid discharge foe created in the reservoir fey means of which the fluid is sucked from the external auxiliary reservoir. By providing a series of multiple reservoirs, any fluid volume can be provided in either embodiment, which again ensures multi-functional operation.

According to a particularly preferred embodiment, the hydraulic assembly according to the invention is preferably connectable to an externally arranged ventilated auxiliary reservoir in fluid-dynamic communication. For this embodiment, the closure cap of the hydraulic assembly is preferably not configured as being air-tight, so that the fluid requirement of additional consumers can be adjusted accordingly, in particular by use of the freely selectable auxiliary reservoir. As an alternative thereto, the hydraulic assembly according to the invention with an externally disposed ventilated auxiliary reservoir is via a fluid fine connectable to the reservoir of the hydraulic assembly, where the closure cap of the hydraulic assembly is then for operation to be configured airtight and the fluid line therefore acts as a suction line by means of which the fluid reservoir can for supplying any number of consumers be expended according to their fluid requirement and therefore preferably no limitations in the filling level of the auxiliary reservoir are given for the operation of the assembly.

Since selection errors by the operator can occur with purely manual program selection, the device has the option that internal process programs are started externally or entire process programs are transmitted from the outside. The external process call can there, depending on how the system is programmed, lead to an automated program start of the hydraulic assembly. For this purpose, a multifunctional reader is connected in a wired or wireless version to the hydraulic assembly. The reader can, for example, comprise a tag reader (label, ticket, tag reader), a 1D, 2D, or a 3D scanner, by means of which an application name of the application or simply an assignment form is scanned The program can be loaded directly fey the multifunctional reader via the application name or e.g. or be sent via WLAN or cable to the hydraulic assembly. It is also possible to have only the application name and additional documentation data, such as the operator name, the serial number of the machine, etc. be transmitted to the hydraulic assembly and the corresponding program is started by the application name in the assembly Another embodiment is the option that that the reader loads the application name starting the program request to a cloud service or an external server and the program is transmitted from there via the reader to the hydraulic assembly and started. As it is to be ensured that the transmitted data arrives at the receiving end without error, it is provided with a checksum, such as, for example, in a cryptographic manner or by hash value. If the checksum does not match the data, a renewed data request to the sender of the message occurs until the correct data is sent. The multifunctional reader can also be, for example, a mobile phone with, for example, Bluetooth or a WLAN connection which via a WLAN hotspot also provides the connection from the hydraulic assembly to a server or a cloud service.

The determined process data is after process termination in a system call transmitted from the hydraulic assembly to the multifunctional reader and back to the server or a cloud service. By use of the cloud service, the received process, system or program data can be stored, analyzed and examined by an authorized group of individuals, for example, by use of a web browser. The connected cloud service furthermore provides the functionality that the user can directly retrieve information about the necessity of maintenance or the necessary exchange of its devices. The client and the user are via the cloud service automatically informed that maintenance work for the system is pending if the client does not want to perform maintenance via the manufacturer, he can himself postpone further reminders by acknowledging that he himself has carried out the safety-related service; he therefore does not receive a maintenance prompt again until the next due date. In addition to the pump assembly, all third-party inventory of the client can by use of this service in the cloud be entered and managed. The assembly therefore with the cloud solution provides an overall approach to maintenance and management for various system arrangements, since a complete hydraulic system always comprises at least one assembly, one connection line, and one tool.

In order to ensure currentness of the software, software updates are via the server and/or the cloud transmitted to the multifunctional hydraulic assembly. Should an update fail, then the original version is restored. This ensures that update failures do not lead to system failures. With the update, firstly, software problems are resolved, and, secondly, new features and tools for controlling are provided.

The interface of the hydraulic assembly is in one embodiment equipped with a graphic operator interface with touch control. User navigation is for reasons of simplification of the operating concept based on the concepts of modem smartphones, as most users have developed an intuitive understanding for them. The instruction manual is incorporated in the hydraulic assembly and can be read via the interface. A direct help function regarding system parameters, program functions, icons, control elements and program parameters can be called, by means of which the selected feature item is described and explained. The assembly therewith ensures immediate help regarding questions in terms of operation and helps with process error messages.

The multifunctional hydraulic assembly is according to a preferred embodiment developed for Intermittently operating bolting tools. Bolting processes require a high standard of process reliability and documentation ability due to the security-related connections, such as in a wind power tower, a crane flange, or a Castor-connection.

The hydraulic assembly can for this purpose, for example, via a sensor interface, provide angle data, inter alia, between the tool and the bolt, and actual data regarding the preload force and the bolt elongation and torque values, and control the process by use of these parameters. The parameters externally provided can in particular there be used as direct control parameters or as check parameters for process validation. For this purpose, the assembly records various process parameters by use of internal sensors.

In particular for more complex tightening procedures, such as tightening controlled by the intermittent yield point, it is due to process reliability particularly advantageous to record the parameter of the bolt elongation possibly directly by length measurement or angle measurement, so that the yield point of the bolt can be reached as precisely and reliably as possible. Other verification methods can by means of a respective sensor be performed relatively easily with the hydraulic assembly, such as the “continued rotation method” by measuring the rotational angle and the torque or equivalent methods.

According to a particularly preferred embodiment of the present invention, it is by centralized data storage, such as in a cloud, possible by means of special services to analyze and evaluate bolting processes. Analyzing data allows various filter criteria, such as s scattering examination when using different lubricants, tightening methods, measurement methods, environmental influences, date range, IO connections, NIO connections, user, program name, clamping lengths, etc. Such methods provide a user of this platform in particular with a continuous improvement process of bolting applications to achieve improved system reliability and economy.

According to another preferred embodiment of the present invention, large or multiple bolting tools are in certain conditions of use employed simultaneously and have a higher fluid requirement than the useable volume that a single assembly can possibly provide. With an external auxiliary reservoir, the desired fluid volume can be expanded according to demand.

Bolting program names can in a further embodiment be read by an application via a reader, which can also be a mobile phone, be loaded from a cloud or a server or from a reading device, be transferred to and started on the assembly or the assemblies, it is also possible that bolting programs that am already present on a local memory device of an assembly are started by a reader externally and execute on an assembly. This method, inter alia, avoids or reduces input errors fey operator staff. The reader can there preferably read either a wide variety of optical codes or tags.

The user can, for example, take pictures of the application with a mobile phone and send , them to an assembly for documenting the case of application. The determined process data, tightening curves, and system data is preferably first visualized and stored internally in the hydraulic assembly and sent with a data connection to a shared server, a cloud, or to a reader, so that centralized data storage, analysis and visualization can be performed.

Maintenance information about an assembly or an accessory can further and according to a further embodiment be scanned by an external reader by use of a tag; it can thereby be ensured, for example, that no maintenance of the safety components is forgotten or overlooked The reader preferably after scanning the tags or the optical code reports the status of the maintenance interval to a user. An authorized group of individuals can fey use of a web browser from all over the world externally access the current database and retrieve, monitor or analyze the stored data. Process errors are then forwarded, for example, directly to a selected group of individuals. Closed quality management can thereby be ensured.

According to a further particularly preferred embodiment, the hydraulic assembly has its own web browser, by means of which other process data in a cloud and/or on a server can be accessed in order to possibly obtain a direct comparison with the old process results and/or processes. Software system updates can be performed via LAN, WLAN, USB, GSM and UMTS interfaces, it can furthermore be checked whether a more recent version of the program is available so that a user can be informed about the possible update. This ensures that the bolting system is always up to date with technology.

The worker is directly visualized and displayed the actual data of a bolting operation via an operator interface. As it is especially useful with a bolting process to also see the history, the display can display in an alphanumeric manner and by an XY plot the angle over moment, time over moment and inclination over angle. The intermittent return stroke phase of the fool due to return angular rotation is in angle-based methods, such as the torque/angle method, the yield-point-driven method, the torque-driven-angle monitored method, and the angle-driven analysis method, preferably hidden because the fool again falls back. In a time-based method without angle sensors, it can further also be selected whether the return stroke phase is visible or hidden.

In order to ensure rapid tool control, a sensor is attached to the bolting tool and defects the position of the drive and via impulses initiates the forward stroke—return stroke control at the hydraulic assembly. It is thereby possible to control a piston return stroke via the hydraulic assembly without any inactive pressure increase needing to take place which requires time, wastes energy, and would lead to a higher operating temperature and a slower tightening procedure and faster tool and assembly wear.

The hydraulic assembly also preferably comprises a removable operator interface, in which, in one embodiment, the start and stop switches for process control are integrated. Attachment of the operator interface independent of a location can be useful in particular for operation in production lines and assembly sites because one can place the interface in a well visible place, which increases ease of use and safety. Several mounting options are available for this, such as a magnetic holder, a belt holder, a hook-and-loop fastener or mounting on screw-on points provided.

The tightening process for a yield-point-driven method is described below by means of an example.

A code carrier, such as a tag, is located on a bolting flange. The content of the tag, whose name references a yield point-driven program. Is read by the portable reader. The user is asked from what source he preferably wants to read the program file, or he is automatically directed to a defined source such as the cloud. In the event of a possible operator selection, the reader itself, a server, a cloud or the assembly are available for this as a possible data source. The data is after user selection either loaded by in a wireless or wired manner from the source and transmitted in a wireless or wired manner to the hydraulic assembly for execution. If the hydraulic assembly is in a receiving-enabled mode, then the program transmitted is started immediately and the operator is prompted to perform vanous settings and/or confirmations. The content of the bolting program is bolting parameters, control parameters, system requirements, bolting sequence and extended user queries. Upon completion of this sequence, the user is informed about the proposed bolting sequence and prompted to start the bolting operation. For this, he must have the appropriate sensors connected and place the bolting tool on the application. The operator starts the bolting process by pressing the start button. During the intermittently running bolting operation, the assembly verifies the entire gradient curve of the tightening process and terminates the bolting process automatically when the programmed relative gradient threshold for the linear gradient is exceeded. This is the parameter for having reached the yield point. The process is also terminated when the operator performs an operator termination, or when the torque is no longer sufficient to continue turning the bolt and thereby successfully tightening it up to the yield point. After completion of the process, the intermitting tool is moved to the starting position and the assembly motor is switched off. The system checks the physical values obtained by comparison to she default values from the bolting program and/or statistical values from the cloud or from the server, if the result is within the desired range, then the operation is evaluated as being “OK” and the output turns green. If the process has errors, then a “NOK” message is given and the output screen on the operator interface and/or the remote control turns red. The operator is then made aware of the next bolting number to which he has to change the bolting tool and the process is repeated until successful completion of the last bolting, which in some cases can be several hundred bolts. If there are individual processes that are marked with “NOK”, then the operator can select directly whether he wants to perform the operation immediately or at a later time, it is possible to adjust the belting sequence as desired. The executed bolting program and the bolting log are combined into a file and changes in the bolting sequence can be viewed in the log. The documentation comprises the entire bolting process in XY coordinates, the end values achieved, the bolting program executed and any additional user inputs and system information.

The hydraulic assembly according to a further preferred embodiment has a PDF generator on which a log is output in pdf format. In order for the bolting logs to be tamper-proof, a checksum is added that makes log tampering evident. During a wireless or wired connection, the log data is transmitted directly after being generated, for example, to a reader, which in turn transmits the data in a wireless or wired manner to a server or a cloud. Depending on the program definition or system settings, however, data can remain stored locally in an assembly and be transmitted at any other desired time in a wireless or wired manner, via USB storage, via a USB interface, LAN or WLAN to a server and/or a cloud. The data in the cloud is archived and stored in a database. Depending on the setting of the service, an authorized group of individuals can after receipt of the data in the cloud automatically be notified when e.g. data has arrived, incorrect data, system messages, or system diagnoses are present, which, for example, require maintenance. But an authorized operator can also throughout the world at any time access the data in the cloud and visualize or view them using specific filters. For example, the possibility exists to filter the data according to a date range, the program name, a user, an assembly type, error logs, error data records, “OK” data records, “OK” logs and/or the clients or other criteria and parameters. This closed process is particularly of relevance for the quality officers of a company, as they can quickly recognize interrelations by means of the results and take corrective action. The QA officer can, for example, customize the program if this is required due to a change of lubricant, a different bolt quality, or different surface textures. He can store the new or modified program in the cloud, and ail further program starts via the reader with a fixed link to the cloud then worldwide occur with the updated program, without there being any risk that individual employees work with the old or wrong standard. For example, each individual process can by means of a cloud be viewed and analyzed as an XY plot providing a high degree of reliability in particular when tracking problems.

The present invention is described below with reference to the following embodiments, where they each only show a possible embodiment of the present invention.

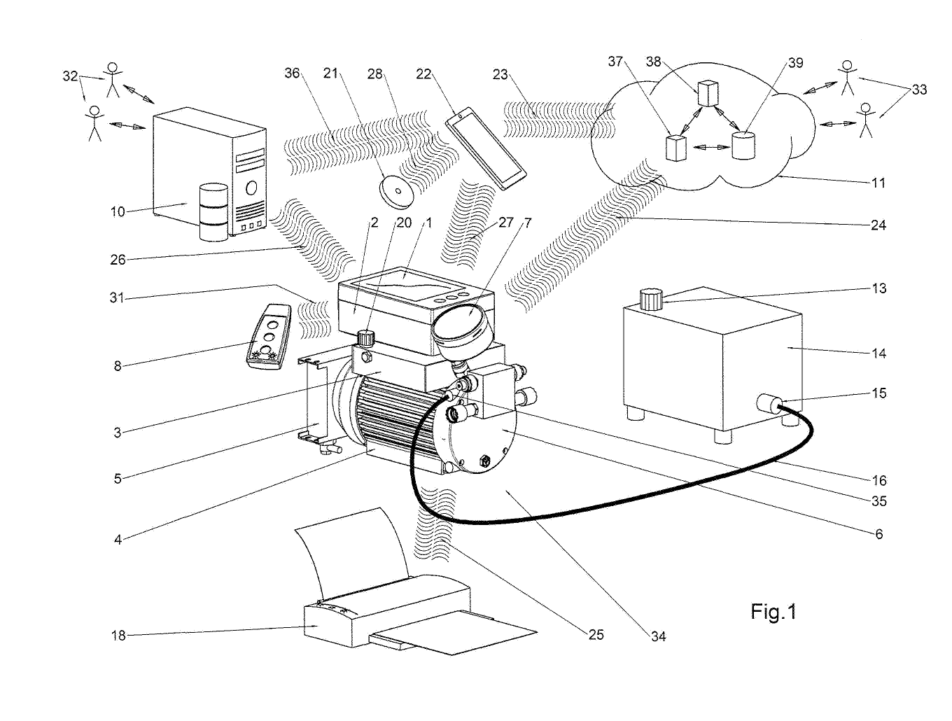

FIG. 1 shows a schematic perspective view of a hydraulic pump assembly according to the invention in a largely wireless configuration and with suction-action auxiliary reservoir;

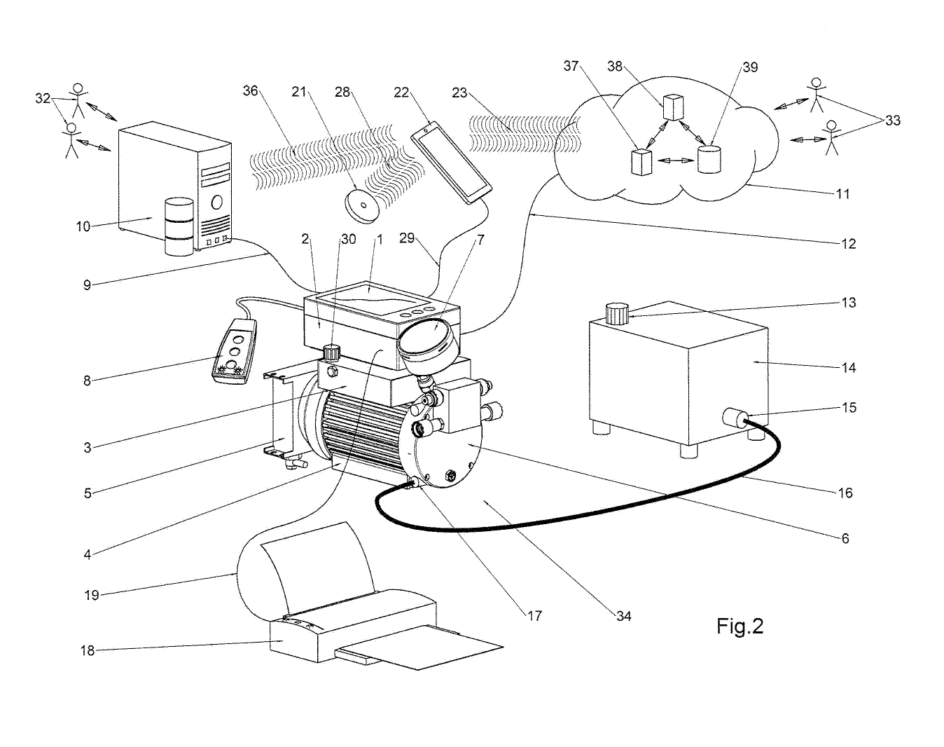

FIG. 2 shows a schematic perspective view of a hydraulic pump assembly according to the invention in a largely wired configuration and with a communicating auxiliary reservoir;

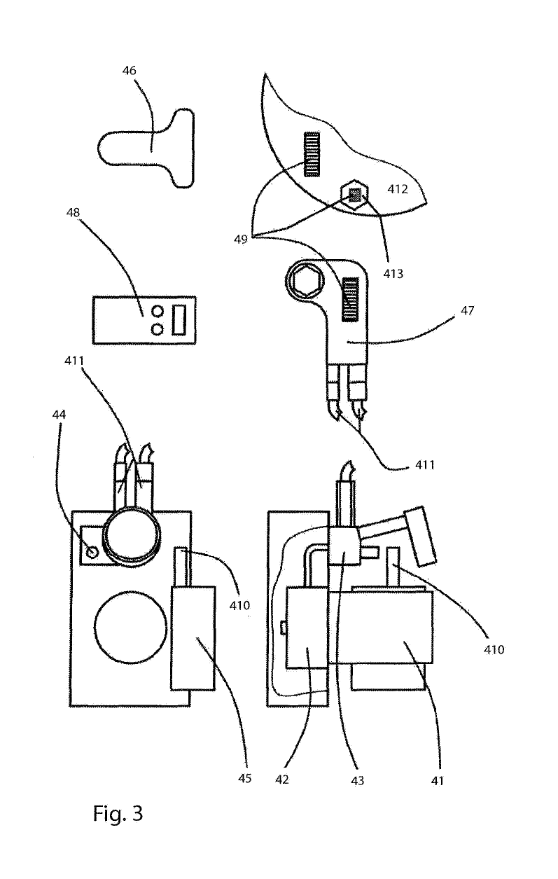

FIG. 3 shows a schematic representation of a further aspect of the present invention.

At issue is a portable motor-driven hydraulic assembly with preferably an oil-immersed motor and at least one piston pump for driving hydraulic tool components, such as intermitting and/or continuously operating bolting tools, lifters, spreaders, clamping devices or similar hydraulic equipment.

Assembly 34 has an internal and/or external data interface (not illustrated) for information transfer and/or for assembly control with at least one server 10 and/or a cloud 11. By means of this interface and the necessary drivers, assembly 34 is able, for example, to operate a radio module (not illustrated) with a GSM—(Grouse Spécial 2), GPRS—(General Packet Radio Service), EDGE—(Enhanced Data Rates for GSM Evolution), UMTS—(Universal Mobile Telecommunications System), HSDPA—(High Speed Downlink Packet Access), LTE—(Long Term Evolution) or WLAN (Wireless Local Area Network) module in order to enable direct remote data exchange 2 or 26 and controlling assembly 34. A group of individuals 33 with access authorization is thereby allowed to access this data via cloud 10. In the event of process results violating rules, a notice is provided for inspection preferably from cloud 11 and/or server 10 to a selected group of individuals 32 or 33 with access authorization 32, either containing measurement data or not. It is thus possible to implement an automated emergency support for procedural problems. The measurement data in cloud 11 and/or in server 10 is furthermore used to analyze mean values, typical scattering, typical success patterns and typical error patterns to obtain better models for the analysis of bolting application data and to thereby continue improving analysis capabilities in a self-contained quality process.

By means of a short-range radio link, such as with radio technology (not illustrated) like WLAN, Bluetooth, ZigBee or the like, the assembly can by means of an additional external e.g. RFID (Radio-Frequency identification)-capable reader 22 for tag 21, or via a 1D, 2D or 3D barcode reader 22 and a corresponding cods (not illustrated) read an application name of a means attached to the application External multifunctional reader 22 composes an interface and special software for controlled data exchange via radio link 23 or 36 to a data server 10 or a cloud 11. Reader 22 there transmits the application name and in return receives from the addressed data storage the associated current program or programs that are transmitted via radio link 27 to the assembly and then started. The process of downloading programs can also already be triggered due to a pending service process and occur in advance onto reader 22, The process of reader 22 reading the application name in this case serves only to verify the correct operation and as a trigger for program transfer to assembly 34. Upon termination or completion of the program, the process result triggered either automatically or manually is sent back via communications link 27 to reader 22, which In turn sends this information via communication link (23 or 36) to selected data storages 10 or 11 or first maintains it in the internal memory. Furthermore, direct data storage is possible from the assembly to a cloud 11 and/or a further server 10 by wired FIG. 2 or wireless FIG. 1 transmission. If either assembly 34 or reader 22 experiences a problem establishing the data connection, then the data is regardless of the data path restricted from being deleted on the devices until they have been successfully sent. This measure reliably rules out loss of data. The connection between the hydraulic assembly and reader 22, server 9, cloud 11 and printer 19 can there also be a wired configuration.

During data transfer to and from external storage 23, and 24 and 26 and 27 and 36, a check sum integrated in the data is checked by the respective terminals of transmission link 10 and 11 and 22 and 34. If checking the check sum delivers an error, a new data request or an error message is transmitted or triggered either by assembly 34 or by external storage 10 or 11 or 22. Should the sender due to a deviation in the checksum recognize that the data record contains an error, then this faulty data record is not sent and the error is reported.

Since hydraulic assembly 34 according to the invention is used for many different requirements such as hydraulic bolting tools, hydraulic lifters, hydraulic spreaders, hydraulic presses, etc, and partly relatively high amounts of fluid are needed, if comprises at least one interface 17 or 35 for the external connection of at least one auxiliary reservoir 14 which in one embodiment, FIG. 2, is connected in communicating operation and in another embodiment, FIG. 1, a suction operation to said reservoir Auxiliary reservoir 14 can there, for example, for a more compact design in a further embodiment (not illustrated) also be fixedly connected to assembly 34. Cap 13 is there configured as a ventilation opening and fluid line 16 is attached via an interface 15 provided for fluid exchange between auxiliary reservoir 14 end assembly 34. In the application example of FIG. 2 with the communicating fluid exchange, connection 17 of fluid line 18 is located at the bottom of the reservoir of assembly 34. In the suction concept, the connection of fluid conduit 16 is located at the fop of the reservoir. For the suction embodiment of auxiliary reservoir 14 at assembly 34, it is necessary that closure cap 20 be configured airtight, so that in the event of a fluid discharge from the reservoir, a negative pressure can arise in the reservoir by which the fluid is sucked out from auxiliary reservoir 14. In the communicating embodiment, however, closure cap 30 must be configured as a ventilation element.

For the different requirements in terms of capacity to be met, assembly 34 is adapted to drive at least one piston pump of different flow rates or simultaneously several pumps of another configuration.

For multifunctional use of assembly 34, direct operation of a printer 18 is possible at an existing interface, such as USB as a wired solution 19 or Bluetooth as a wireless solution via radio link 25. The measurement logs can be outputted directly at the application site according to the program requirements or the user selection and be appended to the documents.

Hydraulic assembly 34 also comprises a standardized sensor interface (not illustrated) for connecting external sensors. This can be, tor example, CAN, Ethernet, 0 . . . 10V, 0 . . . 20 mA, 4 . . . 20 mA or an incremental port of any measured physical unit, the control signals of which are fed into assembly 34 for controlling and/or documentation. In addition, assembly 34 has the option of incorporating freely programmable interpolation value tables by means of which the measured physical quantities can be illustrated modified to their physical units. These measured external input values can be used individually or in combination with the internal system measurement values for process control of assembly 34.

The hydraulic assembly is connected to a remote control 8 which can be embodied as being wireless via radio link 31 or wired and controls assembly 34.

To ensure multifunctional use, assembly 34 comprises at least one operator interface 1 that is connected to electronic assembly 2 and via which programs can be created and retrieved. The desired method and/or process and/or assembly and/or source parameters can there be displayed on a display device 7 and/or operator interface 1. Operator interface 1 is removable in particular for operation of the assembly in production lines and is therefore also operable in a nonstationary manner relative to the assembly.

Motor casing 4 is the motor mount and forms at least a part of the reservoir of the pump (not illustrated). A fluid radiator 5 is located at the face end of the motor in order to ensure multi-functional use, e.g. for continuous operation of the assembly. Incorporated into the fluid circuit is a filling and filter element 3 which is preferably located on top of the assembly, in order to ensure a modular structure, a plug connector interface (not illustrated) is arranged above on filling and filter element 3. On the motor casing, pump block 6 with the hydraulic connection forms the face-side closure of the motor assembly.

In another specific embodiment, for example, a service technician is further supported in his bolting assignment via the networked bolting system. A portable nonstationary unit, such as a table PC, a smartphone, or a head-mounted display, which has loaded the essential assignment data, leads the technician to the job site. Navigation to the job site is done via checksum, geometric data or information, GPS data, travel directions, icons, street name, house number and images, which are recorded in the database for the bolting site and visualized on the table PC or the head-mounted display and communicated to the technician.

The technician can then at the job site by means of a tag reader or a scanner, in particular a barcode reader, scan the data available in the region of the bolting assignment or object, such as an application name. The reader then within the meaning of a verification checks whether the service technician is at the correct job site and in the event of any deviation Informs the technician should the job pertain to a different flange. If the name recorded in the work assignment matches the scanned name, then a specific program is loaded. Loading the bolting program to be executed can be performed in various ways.
a) If an active valid LAN or WLAN connection is available, then the reader imports the bolting program directly from a central database such as a server or a cloud.
b) If there is no WLAN connection available, then the reader can by means of a mobile network connection (mobile phone) load the bolting program from the server or the cloud.
c) if both are not possible or available or a technical defect is given, then the mobile device can also resort to directly loaded data from the work assignment in the internal memory, provided that currentness is ensured within a certain specified time window that is defined by the client.

The program data thus loaded contains all necessary and essential bolting application information, such as data regarding the control factors, the control variables, the bolting method to be applied, the bolting pattern, the lubricant, the connected hydraulic tool, the ambient conditions such as temperature, rain, etc. and are therefore updated on the nonstationary unit. This ensures that no outdated or inappropriate program for the ambient conditions with incorrect tightening values or control values is used.

The nonstationary unit now via radio interface sends this program to the multifunctional hydraulic assembly which recognizes that this bolting program must be started. The multifunctional hydraulic assembly informs the user via the display regarding the activities to be undertaken and in particular regarding all essential parameters of the specific bolting program.

A key aspect is there that the operator is via the bolting pattern, being part of the bolting program, instructed which bolt he has to tighten. The interlace, however, also allows the user documented deviations from the bolting pattern to ensure flexible operations, especially in the event that, for example, bolts need to be checked and must again be tightened in order to obtain the proof of process capability.

Once the last bolting action of the work assignment has been successfully completed, the multifunctional hydraulic assembly transmits the data, firstly, to the internal memory and, secondly, sends the data via the radio interface back to the nonstationary unit or also directly to the server where the bolting application results are stored automatically.

The multifunctional hydraulic assembly via its interfaces and remote control capability for automated program starts allows for a self-contained work process that provides the highest level of security and currentness of data.

The currentness of data there refers to the bolting programs centrally organized end employed and the rapid provision of the results of the successfully completion work assignment.

The bolting application data returned to the server are automatically scanned and analyzed stochastically in terms of deviations from stored comparison procedures Abnormalities are transmitted to the nonstationary unit and the technician is informed to possibly again inspect conspicuous bolt connections. The type of inspection depends on the bolting process performed and the methods employed. For example, mechanical length measurement by means of a micrometer gauge can be employed, but also constant length measurement of the bolt can foe used if bolting methods like yield-point-driven tightening or elastic tightening have been used.

The highest level of process reliability for the work processes performed is ensured in this manner almost in real time and expensive reworking, which, for example, only becomes apparent by a pressure test, is effectively avoided. Executing this work process described requires the automated transmission of bolting programs to the hydraulic bolting system, the remote control capability of the system, and the ability to communicate via the existing data interfaces with other shared network.

In some companies, directly connecting bolting systems with the company's network is for safety reasons undesirable or not possible due to internal policies. The entire bolting program is there created locally on the pump and contains data regarding e.g. the control factors, the control variables, bolting methods to be applied, bolting patterns, the hydraulic tool employed, and other client-specific documentation input can be prescribed such as documentation query regarding ambient influences. If several systems are operated in a company or in a vicinity and bolting programs are modified for an individual system, then a so-called clone can be created which is via a USB memory stick or a WLAN interface transferred to another multifunctional hydraulic assembly. It is thereby ensured in these systems that all bolting systems access the same database and programs created locally can be transferred to all systems.

According to the present invention, a clone is understood to be at least one bolting program, one bolting pattern, measurement data, interpolation value tables regarding tools to be used and machine elements, combinations thereof and the like, which are provided as specific data or a data record for transmission and use for controlling and analyzing a further hydraulic assembly.

The technician, for example, receives a written work assignment for a bolting activity to be performed. The programs are in general already stored locally in the pump and the technician can from a list of programs manually select the program to be executed. Should no bolting program be stored, then the bolting program can be programmed via the input interface of the multifunctional hydraulic assembly according to the parameters specified on the work assignment. The multifunctional hydraulic assembly, however, is in addition to the manual execution of a bolting program also capable of reading a program name via a tag or barcode when directly connected to a reader. Should a program exists with the same name in the multifunctional hydraulic assembly, then it is started automatically after scanning the name, and the technician can thereby avoid mistakes when selecting a program. Required program transfers in the event of a change are performed controlled manually by means of the USB stick and the clone function or a direct radio transmission between the multifunctional hydraulic assemblies. When performing the work assignment, the technician is guided fully supported by She assembly and the interface. Upon successful completion of the bolt connection, automated documentation of the data occurs in the internal assembly memory.

The bolting application performed is by means of a local stochastic module (software) in the assembly checked for abnormalities and abnormal bolt connections are reported to the technician. The software also resorts to other bolting application data which were performed with the same program parameters in order to have a broader data base and to be able to optimally support the technician. The bolting application data can subsequently be transmitted in a manually manner point-to-point via LAN or WLAN to a computer or transferred into the internal corporate network using a USB date storage. With this work process and the stochastic evaluation, the multifunctional hydraulic assembly here as well allows for maximum process reliability and process control for the bolting applications performed.

Another aspect of the invention is explained below in detail with reference to FIG. 3. FIG. 3 at 41 shows a view of a drive unit with a connected impact wrench 47. It comprises a pump unit 42 and a valve unit 43 that is connected to pump unit 42 and configured such that it is connected to two hydraulic lines 411, of which one is connected to a load stroke side and one to a return stroke side of an impact wrench 47. In order to adjust the torque that is required for the bolt connection, valve unit 43 comprises a pressure adjustment valve 44. After belt connection process parameters 49 regarding the operating staff, tool 47, a bolt connection process or a bolt connection application and bolt connection equipment have by means of a nonstationary barcode scanner 46 be recorded, they are wirelessly transmitted to a work unit 45 which displays the compression torque to be adjusted via a display of a control unit 48 after the data has been queried by a storage unit 410. Once the displayed compression torque has been set by the operator at pressure adjustment valve 44, the bolting process can be started and stopped via control unit 48. It is to be noted that the compression torque or the bolting preload force is the force which is necessary for tightening and/or loosening the bolt connection. In an alternative embodiment, which is presently not shown, setting the specific adjustment parameters at pressure adjustment valve 44 is realized directly by forwarding from work unit 45 to pressure adjustment valve 44. Once the adjustment preferably at an electrically controlled pressure adjustment valve has been performed, the bolt connection can be started either automatically or initiated by the operator via activation unit 43. After completion of the bolting process, specific data regarding the bolt connection can be stored by work unit 45 in storage unit 410, where they can be retrieved for later use. In an alternative embodiment, which is presently not shown, control unit 48 can comprise a sensor unit which determines when tool 47 is available to tighten the bolt connection or release it, whereby valve unit 43 becomes actuatable by the control unit. The sensor unit acts as a safety mechanism that helps to prevent injury to personnel. Furthermore, control unit 48 and data recording unit 46 can be combined info a single unit, whereby valve unit 43 is activated by the combined unit.

### LIST OF REFERENCE NUMERALS

1) operator interface
2) electronic assembly
3) filling and filter unit
4) motor casing
5) fluid radiator
6) pump block
7) display device
8) remote control
9) wired connection between the assembly and the PC/server
10) PC/server
11) cloud
12) wired connection between the assembly and the cloud
13) closure cap with ventilation
14) auxiliary reservoir
15) fluid connection at the auxiliary reservoir
16) fluid line
17) fluid connection at the assembly (preferably in communicating operation)
18) printer
19) wired connection between the assembly and the printer
20) airtight closure cap
21) tag
22) reader
23) wireless data transmission between the reader and the cloud
24) wireless data transmission between the assembly and the cloud
25) wireless data transmission between the assembly and the printer
26) wireless data transmission between the assembly and the PC/server
27) wireless data transmission between the assembly and the reader
28) wireless data transmission between the reader and the tag
29) wired connection between the assembly and the reader
30) ventilated closure cap
31) wireless data transmission between the assembly and the remote control
32) authorized group of individuals server
33) authorized group of individuals cloud
34) hydraulic assembly
35) fluid connection at the assembly (preferably in suction operation)
36) wireless data transmission between the reader and the PC/server
37) analysis service
38) web browser service
39) data storage
41) drive unit
42) pump unit
43) valve unit
44) pressure adjustment valve
45) work unit
46) data recording unit
47) tool
48) activation unit
49) bolt connection process parameters
410) storage unit
411) hydraulic lines
412) bolting application
413) bolt connection

1. Hydraulic assembly (34) for a hydraulic bolting system with an electric motor (4), at least one pump stage on a pump block (8), and an electronic assembly (2), characterized in that
said electronic assembly (2) comprises an operator interface (1), and said operator interface (1) is connectable to at least one internal and/or external interface, where said interface is in communication with a data cloud (11) and/or a data server (10) and programs stored by said data cloud and/or said data server are loaded into said electronic assembly (2) and automatically executed by said electronics assembly (2), and
process data and/or system data can by said electronics assembly (2) for the purpose of storage and/or analysis of said data be in an automated manner transmitted back to said data cloud (11) and/or said data server (10).

2. Hydraulic assembly according to claim 1, characterized in that
said electronic assembly (2) is connectable to an internal and/or external storage for bidirectional data exchange of programs and/or process data and/or process parameters and/or system data.

3. Hydraulic assembly according to claim 1, characterized in that
said operator interface (1) is a tablet PC and/or a head-mounted display, in particular a pair of glasses for the detection and specification of information and can in particular be combined to a further input device, such as a microphone, for inputting commands.

4. Hydraulic assembly according to claim 1, characterized in that
said operator interface (1) is attachable by use of a magnetic holder and/or bolt attachments and/or a hook-and-loop fastener and/or a strap fastener and removable from said hydraulic assembly (34) and operable and attachable outside of said hydraulic assembly (34) by use of a magnetic holder and/or bolt attachments and/or a hook-and-loop fastener and/or a strap fastener.

5. Hydraulic assembly according to claim 1, characterized in that
an externally disposed ventilated auxiliary reservoir (14) is connectable in fluid-dynamic communication and said closure cap (30) of said assembly is preferably configured to be ventilated.

6. Hydraulic assembly according to claim 5, characterized in that
an externally arranged ventilated auxiliary reservoir (14) is connectable via a fluid line (18) to said reservoir (4), where said closure cap (20) is for operation configured to be airtight.

7. Hydraulic assembly according to claim 1, characterized m that
said hydraulic assembly (34) is connectable to sensors for providing external sensor signals of any measured physical quantity, where physical actual values are provided by said sensor signals and serve as control variables and/or control quantities and/or actuating variables and/or control parameters and/or additional parameters in said electronics assembly (2) for further processing and process control and hydraulic assembly control and process validation.

8. Hydraulic assembly according to claim 1, characterized in that
said hydraulic assembly (34) is connectable to an external code reader (22), where in particular application names are received with said code reader and internal and/or externally stored program selections are in turn performed by them and/or documentation content for the process and/or maintenance intervals of said hydraulic assembly and/or accessories is recorded and/or visualized and/or stored and/or reported.

9. Hydraulic assembly according to claim 1, characterized in that said external code reader is a mobile phone with camera functionality and that preferably application images and/or optically readable codes are transmitted to said hydraulic assembly (34), said server (10) and/or said cloud (11) for documenting the case of application.

10. Hydraulic assembly according to claim 1, characterized in that
an external printer is connectable to said assembly and outputs process results and/or a process status and/or process quality and/or program information and/or system information and/or service information and/or maintenance information.

11. Method for controlling a device according to claim 1, characterized in that
said assembly receives from said code reader application programs to be executed by said code reader and/or application names, by means of which an automated program start occurs in said hydraulic assembly (34) and/or user information and/or documentation data and/or process information can be scanned and/or stored locally.

12. Method according to claim 11, characterized in that
said external storage (10) or (11) or (22) by means of at least one specific service sends bolting programs and/or software updates and/or notices to said hydraulic assembly for execution by means of which an automated program start and/or program transmission and/or visualization for execution is performed.

13. Method according to claim 11, characterized in that
said hydraulic assembly (34) sends logs and/or system data and/or raw data to said external storage (10) or (11) or (22) which are archived (39) and/or analyzed (37) and/or controlled, forwarded to authorized individuals (32) or (33) and/or visualized via a web browser by means of an online portal (38).

14. Method according to claim 1, characterized in that
analysis programs by comparing data verify and/or assess the quality of process results in said cloud (11) or said external server (10), and/or analysis models are by comparisons based on available data records improved which also allows statistical inspection of processes performed in terms of their quality.

15. Method according to claim 11, characterized in that
at least one externally assignable access authorization is provided for said data in said cloud (11) by means of which a selected group of individuals is given external access to said data and/or is informed in an automated manner when error processes are present, and/or is informed when new process data has arrived.

16. Method according to claim 11, characterized in that
transmitted program data and/or process data and/or system data contains at least one checksum or a higher-quality validity certificate by means of which manipulations and/or error transmissions of said transmitted program data and/or process data and/or system data are detected and/or reported by the recipient and are in the event of error automatically again requested from the sender.

17. Method according to claim 11, characterized in that
a sender of data only after the successful transmission message releases said program data and/or process data and/or system data from his own memory for deletion.

18. Method according to claim 11, characterized in that
access to information regarding necessary service intervals and/or system status messages and/or operating conditions and/or error messages and/or security checks is for authorized individuals ensured by means of a cloud online portal via an external web browser and/or one that is implemented in said assembly.

19. Method according to claim 11, characterized in that
name data and bolting application data recorded in said assignment is compared for plausibility and/or consistency.

20. Method according to claim 11, characterized in that
evaluation of said bolting applications occurs stochastically, preferably in an automated stochastical manner.

21. Method for controlling a device according to claim 1 comprising the steps of:
scanning a bolting application into said electronic assembly (2);
verifying said bolting application in said electronic assembly (2);
loading a bolting program into said electronic assembly (2);
executing said bolting program with said hydraulic assembly (34) for a hydraulic bolting system.

22. Method for controlling a device according to claim 21, characterized in that
scanning a bolting application occurs by means of a tag reader or a scanner, in particular a bar code scanner, where said bolting application is determined directly or indirectly by information that is disposed preferably in the region of said bolting application or the object itself, respectively.

23. Method for controlling a device according to claim 21 characterized in that
verifying said bolting application occurs by further information such as object data, a checksum, geometric data or information, GPS data, travel directions, icons, street name, house number and images, which are stored in a database for said bolting application.

24. Method for controlling a device according to claim 21, characterized in that
loading said bolting program occurs either via an existing LAN or WLAN connection and/or a mobile network connection such as via a mobile phone and thereby provides a connection to a database preferably to a server and/or a cloud for transmitting data, in particular said bolting program.

25. Method for controlling a device according to claim 21 characterized in that
said bolting program provides essential data, such as data regarding control factors, control variables, the bolting method to be applied, the bolting pattern, the lubricant, the connected hydraulic tool, the ambient conditions such as temperature, rain, etc., for said individual bolting application.

26. Method for controlling a device according to claim 21, characterized in that
the operator is informed prior to or at the start of said bolting process about all essential data and/or parameters, such as the specific bolting program, the bolting pattern etc.

27. Method for controlling a device according to claim 21, characterized in that
said electronic assembly, in particular said interface, during said bolting process or when performing said bolting program records and checks all essential operating parameters and procedures, and possibly has automated or operator-performed repetitions performed.

28. Method for controlling a device according to claim 21, characterized in that
proof of process capability is recorded, created or provided preferably using at least one external sensor which detects at least one target value such as a preload force of a bolt connection.

29. Method for controlling a device according to claim 21 characterized in that
said operating parameters recorded preferably in said electronic assembly (2) are after completion of a work assignment in said database transmitted back preferably to a server and/or a cloud, and are used in particular for generating an updated and/or separate bolting program.

30. Method for controlling a device according to claim 21, characterized in that
the actually recorded operating parameters, including any possible changes performed, are after completion of a first work assignment of said bolting program temporarily stored in said electronic assembly (2) and made available as a data record or a new bolting program for further work assignments.

31. Method for controlling a device according to claim 21 characterized in that
a clone of a bolting program for said currently available hydraulic assembly and/or further hydraulic assemblies is provided after completion of a first work assignment of said bolting program and said actually recorded operating parameters.

32. Use of a hydraulic assembly (34) according to claim 1 for fluid supply, in particular with oil supply for tools, such as lifting cylinders, hydraulic bolting tools, torque tools, yield-driven tools, angle-driven torque tools or the like.
